(19) United States
(12) Patent Application Publication
(10) Pub. No.: US 2015/0125050 A1
(43) Pub. Date: May 7, 2015

(54) FINGERPRINT RECOGNITION SENSOR MODULE HAVING SENSING REGION SEPARATED FROM ASIC

(71) Applicant: DREAMTECH CO., LTD, Seongnam-si (KR)

(72) Inventors: Jin-Seong LEE, Anyang-si (KR); Jong-Hwa KIM, Seoul (KR); Kyoung-Jun PARK, Cheonan-si (KR); Ho-Chul JOUNG, Yongin-si (KR); Young-Ho KIM, Yongin-si (KR)

(21) Appl. No.: 14/532,372

(22) Filed: Nov. 4, 2014

(30) Foreign Application Priority Data
Nov. 5, 2013 (KR) 10-2013-0133635
Oct. 24, 2014 (KR) 10-2014-0144679

(51) Int. Cl. G06K 9/00

(52) U.S. Cl. CPC G06K 9/0002
USPC 382/124; 29/841

(57) ABSTRACT

Disclosed is a fingerprint recognition sensor module including a flexible printed circuit board. The flexible printed circuit board includes a first sensing region formed with a first sensing input unit, a second sensing region formed with a second sensing input unit, a chip mounting region on which an ASIC is mounted to convert a fingerprint sensed through the input units into a digital signal and transmit the digital signal to a connector, and a connection section to which the connector is connected. The chip mounting region and the first and second sensing regions are separated from each other on the same surface, and the flexible printed circuit board is folded such that projection planes of the chip mounting region and the first and second sensing regions are superposed one above another.

### CROSS-REFERENCE TO RELATED APPLICATION

This application claims priority to Korean Patent Application No. 10-2013-0133635 filed on Nov. 5, 2013, and Korean Patent Application No. 10-2014-0144679 filed on Oct. 24, 2014, and all the benefits accruing therefrom under 35 U.S.C. §119, the contents of which is incorporated by reference in its entirety.

### BACKGROUND

1. Technical Field

The present invention relates to a fingerprint recognition sensor module, and more particularly, to a fingerprint recognition sensor module having a sensing region separated from an ASIC to enhance sensing performance and process yield.

2. Description of the Related Art

Fingerprint recognition technologies are widely used in user registration and authentication procedures to prevent security breaches. Particularly, fingerprint recognition technologies are applied to personal and systematic network defense, protection of various content and data, and stable access control.

In recent years, as a variety of mobile devices including smartphones and tablet PCs are widely used, personal information and content recorded and stored in the mobile devices are frequently leaked regardless of user intention.

In the related art, fingerprint recognition functions are applied to some mobile devices such as smartphones and notebooks. However, fingerprint scanners are attached to mobile devices such that they are visible to the eye, thereby causing security problems and limitations to design of the mobile devices.

The present invention is aimed at providing a fingerprint recognition sensor module that may be applied as a home key to mobile devices. Korean Patent Publication No. 10-2002-0016671 A (published on Mar. 6, 2002) discloses a portable information terminal in which a fingerprint recognition module is embedded, and a control method thereof.

### BRIEF SUMMARY

It is one aspect of the present invention to provide a fingerprint recognition sensor module having excellent sensing performance and high process yield.

It is another aspect of the present invention to provide a fingerprint recognition sensor module in which sensing regions are formed to be separated from an ASIC, thereby ensuring flatness of a sensing plane not only before coating but also in an end product.

It is a further aspect of the present invention to provide a fingerprint recognition sensor module that can enhance fingerprint sensing performance and recognition rates by ensuring flatness of a sensing region.

It is yet another aspect of the present invention to provide a touch type fingerprint recognition sensor module in which transmitter and receiver regions respectively corresponding to first and second sensing regions of a sensing unit are superposed one above another, thereby reducing manufacturing costs.

It is yet another aspect of the present invention to provide a fingerprint recognition sensor module in which a stiffener is attached to a rear surface of a sensing region to secure flatness of a sensing plane, and a surface of the stiffener is formed to be convex, thereby achieving stable fingerprint sensing.

The present invention is not limited to these aspects, and other aspects and advantages of the present invention not mentioned above will be understood through the following description, and more clearly understood from exemplary embodiments of the present invention. In addition, it will be easily appreciated that the aspects and advantages are realized by features and combination thereof as set forth in claims.

In accordance with one aspect of the present invention, a fingerprint recognition sensor module includes a flexible printed circuit board, which includes: a first sensing region formed with a first sensing input unit; a second sensing region formed with a second sensing input unit; a chip mounting region on which an ASIC is mounted, the ASIC converting a fingerprint sensed through the input units into a digital signal and transmitting the digital signal to a connector; and a connection section to which the connector is connected, wherein the chip mounting region and the first and second sensing regions are separated from each other on the same surface, and the flexible printed circuit board is folded such that projection planes of the chip mounting region and the first and second sensing regions are superposed one above another.

In accordance with another aspect of the present invention, a fingerprint recognition sensor module includes a flexible printed circuit board, which includes: a first sensing region formed with a first sensing input unit; a second sensing region formed with a second sensing input unit; a chip mounting region on which an ASIC is mounted, the ASIC converting a fingerprint sensed through the input units into a digital signal and transmitting the digital signal to a connector; and a connection section to which the connector is connected, wherein the chip mounting region and the first and second sensing regions are separated from each other, the first and second sensing regions are formed on one surface, and the chip mounting region is formed on the other surface of the flexible printed circuit board, in which the flexible printed circuit board is folded such that projection planes of the chip mounting region and the first and second sensing regions are superposed one above another.

In accordance with a further aspect of the present invention, a fingerprint recognition sensor module includes a flexible printed circuit board, which includes: a first sensing region formed with a first sensing input unit; a second sensing region formed with a second sensing input unit; a chip mounting region on which an ASIC is mounted, the ASIC converting a fingerprint sensed through the input units into a digital signal and transmitting the digital signal to a connector; and a connection section to which the connector is connected, wherein the chip mounting region and the first and second sensing regions are separated from each other, the first sensing region is formed on one surface, the second sensing region is formed on the other surface, and the chip mounting region is formed on one of both surfaces of the flexible printed circuit board, in which the flexible printed circuit board is folded such that projection planes of the chip mounting region and the first and second sensing regions are superposed one above another.

In accordance with yet another aspect of the present invention, a fingerprint recognition sensor module includes a flexible printed circuit board, which includes: a first sensing region formed with a first sensing input unit; a second sensing region formed with a second sensing input unit; a chip mounting region on which an ASIC is mounted, the ASIC converting a fingerprint sensed through the input units into a digital signal and transmitting the digital signal to a connector; and a connection section to which the connector is connected, wherein the first and second sensing regions are formed on both surfaces of the same region of the flexible printed circuit board, respectively, and the chip mounting region is formed to be separated from the first and second sensing regions, in which the flexible printed circuit board is folded such that projection planes of the chip mounting region and the first and second sensing regions are superposed one above another.

In accordance with yet another aspect of the present invention, a fingerprint recognition sensor module includes a flexible printed circuit board, which includes: a first sensing region formed with a first sensing input unit; a second sensing region formed with a second sensing input unit; a chip mounting region on which an ASIC is mounted which embodies a signal sensed through the input units; and a connection section to which the connector is connected, wherein the first and second sensing regions are stacked on one surface of the same region of the flexible printed circuit board and the chip mounting region is formed to be separated from the first and second sensing regions, in which the flexible printed circuit board is folded such that projection planes of the chip mounting region and the first and second sensing regions are superposed one above another.

The fingerprint recognition sensing module may further include a stiffener attached to the stacked first and second sensing regions to secure flatness and strength of the sensing regions.

The stiffener may have a flat or convex curved surface to be attached to the sensing regions, and the convex curved surface may correspond to the shape of a finger.

The stiffener may be interposed between the superposed sensing regions and the chip mounting region and may have a receiving slot formed on a surface thereof facing the chip mounting region and receiving the ASIC.

A functional coating layer may be formed on surfaces of the stacked first and second sensing regions to increase a fingerprint recognition rate.

The functional coating layer may have a thickness of 10 μm to 50 μm to increase a sensing rate.

The functional coating layer may include a high-k dielectric material layer.

The fingerprint recognition sensor module may further include a bezel surrounding the stacked first and second sensing regions and a side surface of the stiffener attached thereto.

The bezel may be formed of a metallic material conducting electricity, and a portion of the bezel which a user touches with a finger may be coated with a nonconductive material.

In accordance with yet another aspect of the present invention, a method of fabricating a fingerprint recognition sensing module includes: (a) preparing a flexible printed circuit board and an ASIC to be mounted on the flexible printed circuit board, and mounting the ASIC on the flexible printed circuit board, the flexible printed circuit board comprising a first sensing region, a second sensing region, a chip mounting region on which the ASIC is mounted, and a connection section to which a connector is connected; (b) attaching a stiffener to a rear surface of the superposed first and second sensing regions to secure flatness thereof; (c) forming a coating layer on surfaces of the first and second sensing regions; (d) attaching a bezel to a periphery of the first and second sensing regions; and (e) connecting the connector to the connection section of the flexible printed circuit board.

The method may further include bonding the first and second sensing regions through folding after operation (a) and forming a shape of the fingerprint recognition sensor module by cutting the flexible printed circuit board formed in an array shape in which the sensing regions are bonded.

Attaching the stiffener may include attaching the stiffener after the first and second sensing regions are superposed one above another by folding the flexible printed circuit board.

Forming the coating layer may include attaching a functional coating layer formed through a separate process to the surfaces of the first and second sensing regions.

As described above, embodiments of the invention provide fingerprint recognition sensor modules in which sensing regions are separated from a chip mounting region on which an ASIC is mounted, thereby enhancing sensing sensitivity.

In addition, embodiments of the invention provide fingerprint recognition sensor modules in which a stiffener is bonded to a rear surface of a sensing region to secure flatness thereof, and a stiffener surface is formed to be convex so that the sensing region bonded thereto is made convex to enhance contact performance between a finger and the sensing region, thereby increasing sensing sensitivity.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a plan view of a flexible printed circuit board for fabrication of a fingerprint recognition sensor module according to a first embodiment of the present invention;

FIG. 2 is a side view of the flexible printed circuit board according to the first embodiment of the invention;

FIG. 3 is a longitudinal sectional view showing a stack structure of the flexible printed circuit board according to the first embodiment of the invention;

FIG. 4 is a side view of a flexible printed circuit board for fabrication of a fingerprint recognition sensor module according to a second embodiment of the present invention;

FIG. 5 is a side view of a flexible printed circuit board for fabrication of a fingerprint recognition sensor module according to a third embodiment of the present invention;

FIG. 6 is a side view of a flexible printed circuit board for fabrication of a fingerprint recognition sensor module according to a fourth embodiment of the present invention;

FIG. 7 is a side view of a flexible printed circuit board for fabrication of a fingerprint recognition sensor module according to a fifth embodiment of the present invention;

FIG. 8 is a plan view of a flexible printed circuit board for fabrication of a fingerprint recognition sensor module according to a sixth embodiment of the present invention;

FIG. 9 is an exploded perspective view showing a flexible printed circuit board and a stiffener of a fingerprint recognition sensor module according to the present invention;

FIG. 10 is a perspective view showing an attachment state of the flexible printed circuit board and the stiffener of the fingerprint recognition sensor module according to the present invention;

FIG. 11 is a perspective view showing a state in which the stiffener is attached to the flexible printed circuit board of the fingerprint recognition sensor module according to the present invention and a chip mounting region is folded toward a bottom surface of the stiffener;

FIG. 12 is a section view showing one example of a stiffener, having a convex curved surface, of a fingerprint recognition sensor module according to the present invention;

FIG. 13 is an exploded perspective view showing a state before attachment of a bezel to a fingerprint recognition sensor module according to the present invention;

FIG. 14 is a perspective view showing a state after attachment of the bezel to the fingerprint recognition sensor module according to the present invention; and

FIG. 15 is a flowchart showing a method of fabricating a fingerprint recognition sensor module according to the present invention.

<List of Reference Numerals>

| | |
|---|---|
| 110: Flexible printed circuit board | 112: First sensing region |
| 114: Second sensing region | 116: Chip mounting region |
| 118: Connection section | 120: ASIC |
| 140: Stiffener | 150: Bezel |
| 160: Connector | |

### DETAILED DESCRIPTION

Hereinafter, exemplary embodiments of the present invention will be described in to detail with reference to the accompanying drawings. Here, all terms and words used in the specification and claims should not be construed as limited to common or lexical definitions and should be interpreted as definitions and concepts corresponding to the spirit and scope of the present invention based on the principle that inventors may pertinently define concepts of the terms in order to describe their own disclosures in the best way. In addition, since embodiments described in the specification and configurations shown in the accompanying drawings are merely exemplary embodiments of the present invention and do not represent the spirit of the present invention, it should be understood that there may be various equivalents and modifications can be made at the time of filing the present application.

In general, a flexible printed circuit board for fabrication of a fingerprint recognition sensor module is formed on one surface thereof with a chip mounting region on which a chip for fingerprint recognition (hereinafter, referred to as an ASIC) is mounted and on the other surface thereof with sensing regions opposite to the chip mounting region. The ASIC is formed of a hard material such as ceramic or silicon, whereas the flexible printed circuit board is formed of a thin soft material, which causes flexure at a bonding interface between the ASIC and the flexible printed circuit board. As a result, it is difficult to secure flatness of a sensing plane. That is because flexure occurs at a bonding interface between heterogeneous materials due to shrinkage or expansion.

Flexure on a sensing plane that is a surface of a sensing region causes degradation in sensing performance and poor external appearance of an end product.

The present invention is characterized in that, in designing a flexible printed circuit board, sensing regions are separated from a chip mounting region on which an ASIC is mounted, thereby ensuring flatness of the sensing regions.

Hereinafter, fingerprint recognition sensor modules having a sensing region separated from an ASIC according to embodiments of the invention will be described in detail with reference to the accompanying drawings.

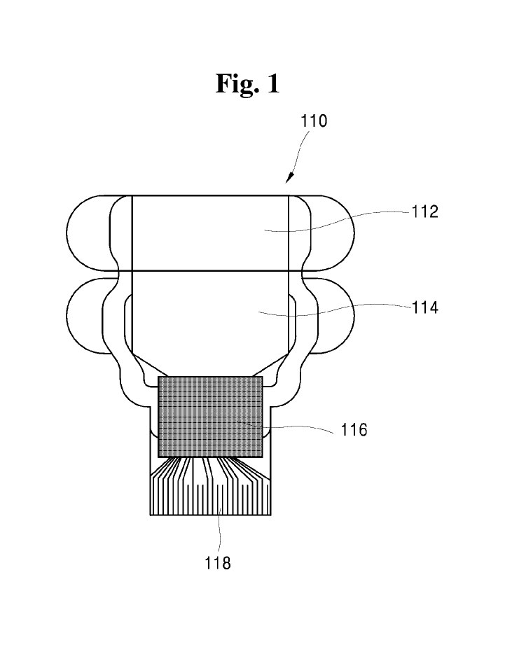

FIG. 1 is a plan view of a flexible printed circuit board for fabrication of a fingerprint recognition sensor module according to a first embodiment of the invention.

Referring to FIG. 1, a flexible printed circuit board 110 for fabrication of a fingerprint recognition sensor module according to the first embodiment of the invention includes a first sensing region 112 formed with a first sensing input unit, a second sensing region 114 formed with a second sensing input unit, a chip mounting region 116 on which an ASIC operated in response to signals sensed through the sensing input units is mounted, and a connection section 118 to which a connector for connection to a device is attached.

The first and second sensing input units are functionally separated from each other. One of the first and second sensing input units may be a transmitter and the other may be a receiver.

A continuous current flow in the transmitter induces a uniform magnetic field. Here, when the transmitter is touched with a finger, there is a variation in the current flow in the transmitter so that distribution of the magnetic field changes with the shape of a fingerprint. The receiver senses the change in the magnetic field distribution of the transmitter and transmits the sensed change to the ASIC.

The first sensing input unit may be a transmitter, and the second sending input unit may be a receiver, or vice versa.

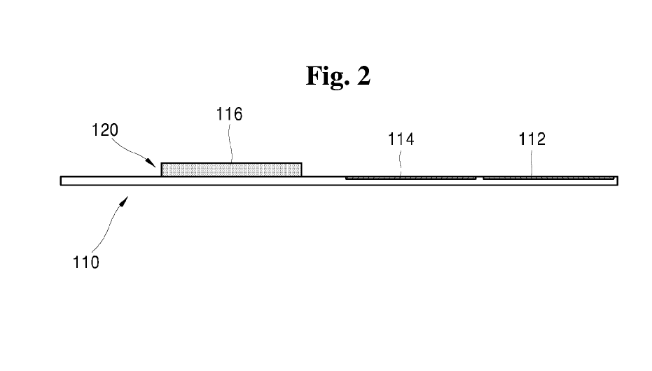

FIG. 2 is a side view of the flexible printed circuit board for fabrication of a fingerprint recognition sensor module according to the first embodiment of the invention.

FIG. 2 shows an ASIC 120 mounted on the chip mounting region of the flexible printed circuit board. Referring to FIG. 2, in the flexible printed circuit board 110 according to the first embodiment, the first and second sensing regions 112, 114 and the chip mounting region 116 are formed on the same surface of the flexible printed circuit board. In this embodiment, a low-priced, single-sided substrate may be used instead of a high-priced, double-sided substrate.

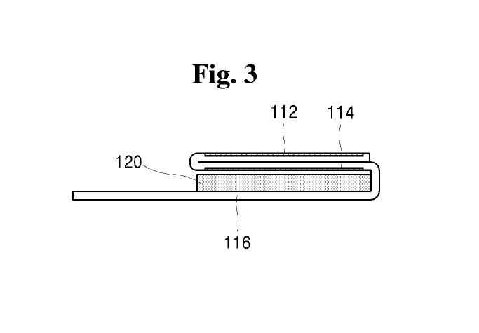

FIG. 3 is a sectional view showing a stack structure of the flexible printed circuit board for fabrication of a fingerprint recognition sensor module according to the first embodiment of the invention.

As described above, in the fingerprint recognition sensor module according to the first embodiment, the first and second sensing regions 112, 114 and the chip mounting region 116 are separated from each other on the same surface of the flexible printed circuit board to be folded. More specifically, the flexible printed circuit board is folded such that projection areas of the first and second sensing regions 112, 114 are superposed one above another, and then folded such that the chip mounting region 116 on which the ASIC 120 is mounted is placed below the superposed sensing regions.

When the fingerprint recognition sensor module is formed by folding the flexible printed circuit board in this way, the first and second sensing regions 112, 114 and the chip mounting region 116 are superposed one above another. In the embodiment shown in FIG. 3, the first sensing region 112 is superposed on the second sensing region 114. Alternatively, the second sensing region 114 may be superposed on the first sensing region 112.

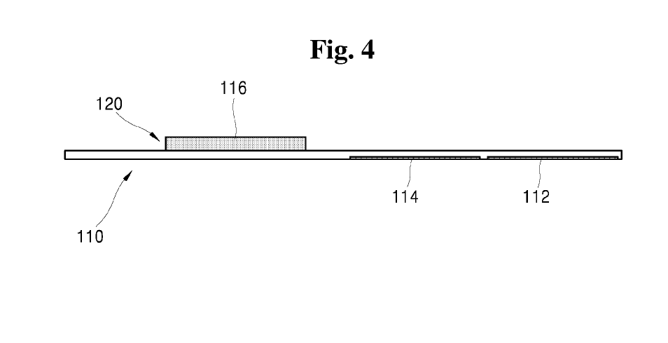

FIG. 4 is a side view of a flexible printed circuit board for fabrication of a fingerprint recognition sensor module according to a second embodiment of the invention.

The second embodiment is the same as the first embodiment in that first and second sensing regions 112, 114 and a chip mounting region 116 are formed to be separated from each other. However, in the first embodiment, the first and second sensing regions 112, 114 and the chip mounting region 116 are formed on the same surface, whereas in the second embodiment, the first and second sensing regions 112, 114 are formed on the same surface and the chip mounting region 116 is formed on a surface opposite to the surface on which the sensing regions 112, 114 are formed.

As in the first embodiment, the first and second sensing regions 112, 114 and the chip mounting region 116 are also superposed one above another in the finished fingerprint recognition sensor module according to the second embodiment, and thus repetitive descriptions thereof will be omitted.

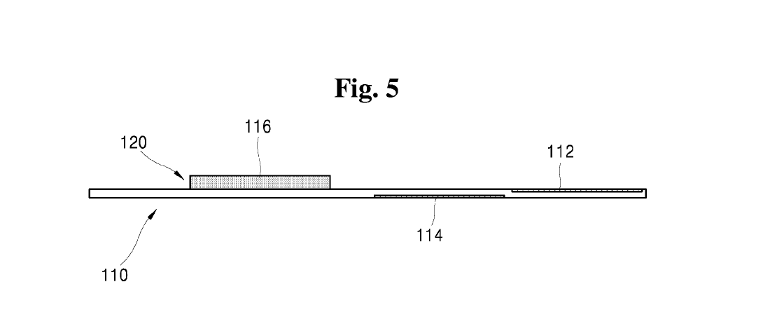

FIG. 5 is a side view of a flexible printed circuit board for fabrication of a fingerprint recognition sensor module according to a third embodiment of the invention.

The third embodiment is the same as the aforementioned embodiments in that first and second sensing regions 112, 114 and a chip mounting region 116 are formed to be separated from each other. However, in the third embodiment, the first and second sensing regions 112, 114 are formed on different surfaces.

Although the chip mounting region 116 and the first sensing region 112 are formed on the same surface in FIG. 5, the chip mounting region 116 and the second sensing region 114 may also be formed on the same surface.

As in the aforementioned embodiments, the first and second sensing regions 112, 114 and the chip mounting region 116 are also superposed one above another in the finished fingerprint recognition sensor module according to the third embodiment.

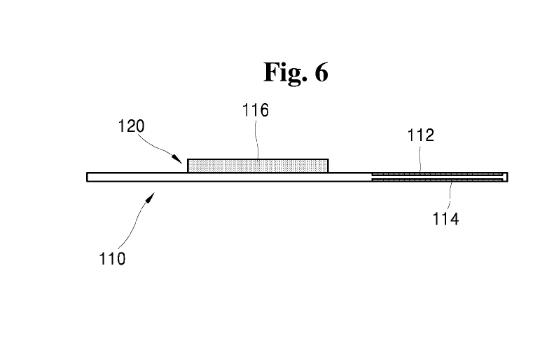

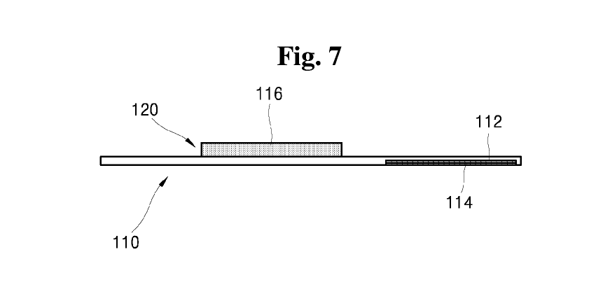

FIG. 6 is a side view of a flexible printed circuit board for fabrication of a fingerprint recognition sensor module according to a fourth embodiment of the present invention, and FIG. 7 is a side view of a flexible printed circuit board for fabrication of a fingerprint recognition sensor module according to a fifth embodiment of the present invention.

In the fourth embodiment, first and second sensing regions 112, 114 are formed on both surfaces of the same region, respectively, and a chip mounting region 116 is separated from the first and second sensing regions.

In the fifth embodiment, first and second sensing regions 112, 114 are stacked on one surface of the same region, and a chip mounting region 116 is separated from the first and second sensing regions.

In the aforementioned embodiments, the fingerprint recognition sensor modules are manufactured by forming the first and second sensing regions 112, 114 in the separated regions on the same surface, followed by superposing the first sensing region 112 on the second sensing region 114 through folding. In contrast, in the fourth embodiment, the first and second sensing regions 112, 114 are formed on both surfaces of the same region, and in the fifth embodiment, the first and second sensing regions 112, 114 are stacked on one surface of the same region, thereby omitting a process of superposing the sensing regions through folding.

Although the chip mounting region 116 and the first sensing region 112 are illustrated as being formed on the same surface in FIG. 6, the chip mounting region 116 and the second sensing region 114 may also be formed on the same surface.

Although the chip mounting region 116 and the first and second sensing region 112,114 are illustrated as being formed on different surfaces in FIG. 7, the chip mounting region 116 and the second sensing region 112,114 may also be formed on the same surface.

The fourth and fifth embodiments are different from the aforementioned embodiments in that the sensing regions are superposed one above another in manufacture of the flexible printed circuit board. However, as in the aforementioned embodiments, the sensing regions are formed to be separated from the chip mounting region 16, thereby suppressing flexure of the sensing regions. In addition, as in the aforementioned embodiments, the first and second sensing regions 112, 114 and the chip mounting region 116 are also superposed one above another in a finished fingerprint recognition sensor module.

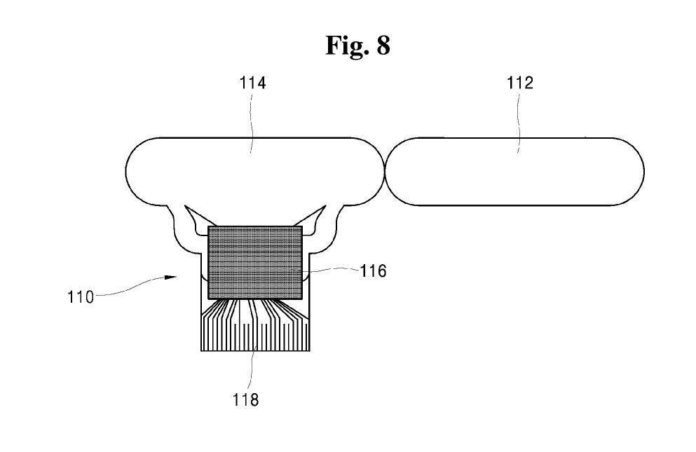

FIG. 8 is a plan view of a flexible printed circuit board for fabrication of a fingerprint recognition sensor module according to a sixth embodiment of the invention.

Although the first and second sensing regions 112, 114 and the chip mounting region 116 are longitudinally arranged in a line in the first embodiment, first and second sensing regions 112, 114 may also be laterally arranged, as shown in FIG. 8.

In addition, although the first sensing region 112 is illustrated as being arranged at a right side of the second sensing region 114 in the embodiment of FIG. 8, the first sensing region 112 may also be arranged at a left side of the second sensing region 114.

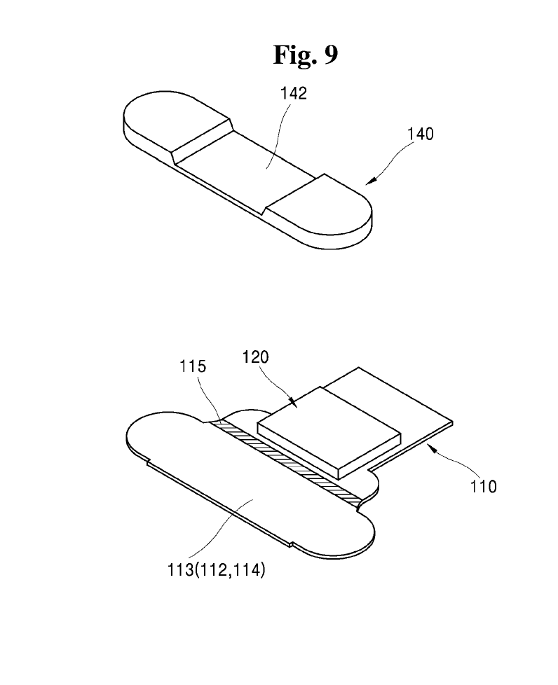

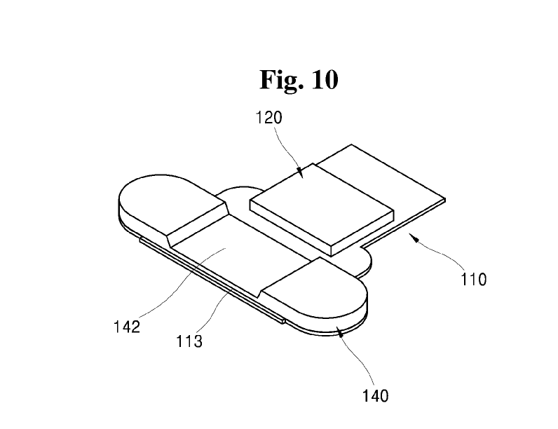

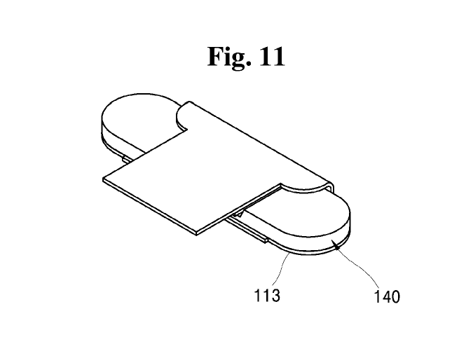

FIG. 9 is an exploded perspective view showing a flexible printed circuit board and a stiffener of a fingerprint recognition sensor module according to the present invention, FIG. 10 is a perspective view showing an attachment state of the flexible printed circuit board and the stiffener of the fingerprint recognition sensor module according to the present invention, and FIG. 11 is a perspective view showing a state in which the stiffener is attached to the flexible printed circuit board of the fingerprint recognition sensor module according to the present invention and a chip mounting region is folded toward a bottom surface of the stiffener.

In the fingerprint recognition sensor modules according to the present invention, a superposed sensing regions 113 are formed by superposing the first sensing region on the second sensing region through folding the flexible printed circuit board (first to third embodiments), by forming the first and second sensing regions on both surfaces of the flexible printed circuit board, respectively, (fourth embodiment), or by stacking the first and second sensing regions on one surface of the flexible printed circuit board (fifth embodiment). In another way, the sensing regions 113 are formed on one surface of a flexible printed circuit board, in which first and second sensing functional units may be intermingled with each other.

However, the superposed sensing regions 113 are merely a doubly superposed flexible printed circuit board or a single flexible printed circuit board. Therefore, the superposed sensing regions 113 are likely to have a crooked surface due to ductility thereof.

According to the present invention, a stiffener is attached to the superposed sensing regions 113 to secure flatness of the superposed sensing regions 113.

Although a stiffener 140 may be attached to the superposed sensing regions 113 by thermal fusion, adhesives or double-sided adhesive tapes may also be used instead of thermal fusion.

A functional coating layer is formed on one surface of the superposed sensing regions 113. The stiffener 140 may be attached to the other surface of the superposed sensing regions 113 before formation of the functional coating layer, thereby omitting or reducing a flatting process during formation of the functional coating layer.

The functional coating layer may include a primer layer, a painting layer, and a UV curing layer, and the respective coating layers may have enhanced permittivity by adding a high-k dielectric material thereto.

The functional coating layer preferably has a thickness of 10 μm to 50 μm to secure sensing performance.

The stiffener 140 for increasing flatness and strength of the sensing regions 113 may be formed of metallic foil or a synthetic resin injection-molded material.

Although the stiffener 140 may be formed of any material capable of ensuring flatness and strength thereof, it is advantageous in terms of cost and usability that the stiffener 140 be formed of a plastic injection-molded material. The stiffener 140 also needs thermal resistance in consideration of attachment to the sensing regions through thermal fusion.

In addition, the stiffener 140 may have a receiving slot 142 capable of receiving an ASIC 120. The receiving slot is formed in a region of the stiffener 140 on which the ASIC 120 is superposed, thereby reducing the thickness and size of the fingerprint recognition sensor module.

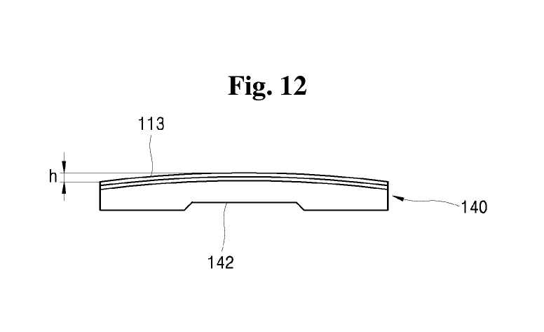

The stiffener 140 attached to the superposed sensing regions 113 may have a flat surface as shown in FIGS. 9 to 11 or a convex curved surface as shown in FIG. 12. In this case, the stiffener 140 preferably has a height (h) of about 1 mm. When the sensing regions 113 have a convex central portion, pressing force increases upon touching the sensing regions 113 with a finger, thereby enhancing sensing performance. However, when the stiffener 140 has an excessive height (h), a contact area is reduced and local pressure applied to the sensing regions 113 is increased, whereby sensing performance can be somewhat degraded.

Reference numeral 115 in FIG. 9 denotes a folding region of the flexible printed circuit board. The folding region may be folded forward or backward.

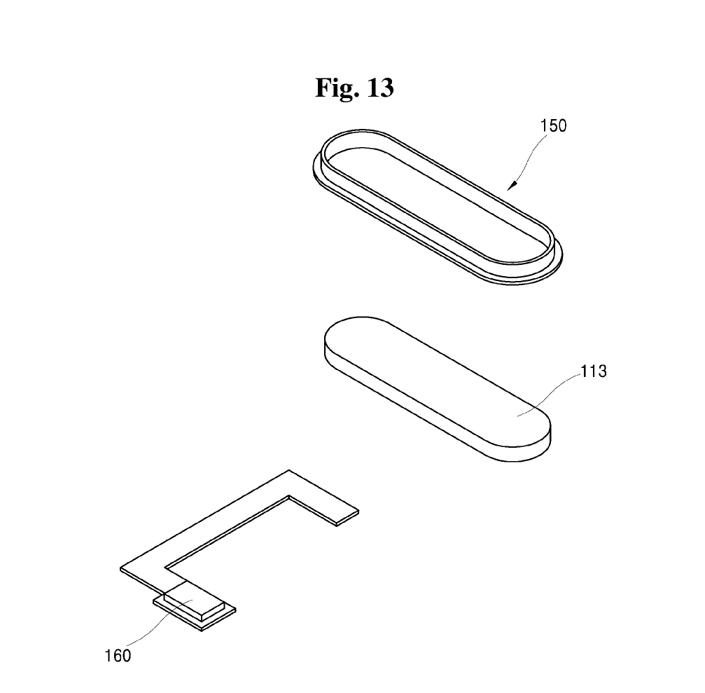

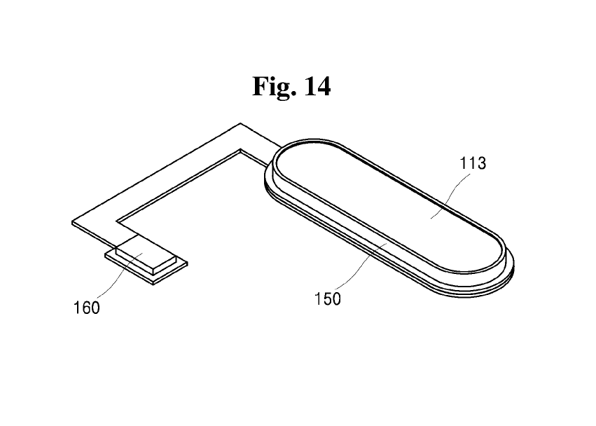

FIG. 13 is an exploded perspective view showing a state before attachment of a bezel to a fingerprint recognition sensor module according to the present invention, and FIG. 14 is a perspective view showing a state after attachment of the bezel to the fingerprint recognition sensor module according to the present invention.

Referring to FIGS. 13 and 14, the fingerprint recognition sensor module may include a bezel 150 that surrounds superposed sensing regions. The bezel 150 functions as an ornament to enhance aesthetics and protect the sensing regions.

The bezel may be formed of a metallic material capable of conducting electricity, without any specific limitation. An upper portion of the metallic bezel 150 which a user touches with a finger is preferably coated with a nonconductive material to prevent electric shock and ensure sensing reliability.

In contrast, a lower portion of the bezel 150 adjacent to an ASIC 120 is preferably formed to conduct electricity to prevent damage of the ASIC 120 due to static electricity. To this end, the bezel may be completely coated with a nonconductive material and then only the lower portion of the bezel may be formed to conduct electricity through additional laser processing.

A connector 160 is attached to a connection section 118 of the flexible printed circuit board 110, and the fingerprint recognition sensor module is connected to a device, such as a cellular phone, through the connector 160.

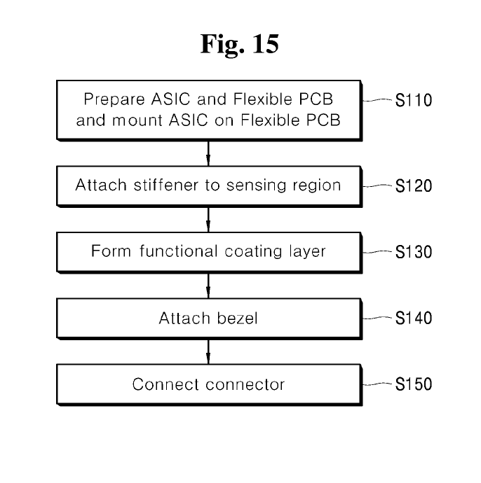

FIG. 15 is a flowchart showing a method of fabricating a fingerprint recognition sensor module according to the present invention.

The method of manufacturing a fingerprint recognition sensor module according to the present invention includes: mounting an ASIC on a flexible printed circuit board including a first sensing region, a second sensing region, a chip mounting region on which the ASIC is mounted, and a connection section to which a connector is attached (S110); bonding the first and second sensing regions through folding such that the first and second sensing regions are superposed one above another and attaching a stiffener to a rear surface of the superposed sensing regions through thermal fusion (S120); sequentially forming a primer layer, a paint layer, and a UV curing layer on a surface of the superposed sensing regions (S130); attaching a bezel to the superposed sensing regions to surround a periphery of the superposed sensing regions (S140); and connecting a connector to the connection section of the flexible printed circuit board (S150).

In operation S110 of mounting the ASIC on the flexible printed circuit board, the flexible printed circuit board may be prepared, as shown in FIG. 13, by manufacturing a plurality of flexible printed circuit boards in an array shape, followed by separating the flexible printed circuit boards through punching.

The ASIC may be mounted on the flexible printed circuit board by anisotropic conductive paste (ACP) bonding, anisotropic conductive adhesive (ACA) bonding, flip chip bonding, or surface mount technology.

In operation S120 of superposing the sensing regions and attaching the stiffener, the first and second sensing regions may be bonded to each other using a double-sided adhesive tape, and the stiffener may be attached to the superposed sensing regions by thermal fusion using a thermal bonding tape. The thermal bonding tape is temporarily bonded to the flexible printed circuit boards of the array shape, cut together in punching the flexible printed circuit boards, and bonded with the stiffener by thermal fusion.

In operation S130 of forming the functional coating layer, the primer layer, the painting layer, and the UV curing layer are sequentially formed on a surface of the sensing regions.

The primer layer serves to enhance adhesive performance between the paint layer and the flexible printed circuit board, considering that the paint layer is not well attached to the flexible printed circuit board made of polyimide. The primer layer may be formed of urethane or a UV coating material. In addition, the flexible printed circuit board may be subjected to surface treatment using plasma and then the primer layer may be formed on the flexible printed circuit board.

The method of manufacturing a fingerprint recognition sensor module may include coating a high-k dielectric material on the primer layer.

The high-k dielectric material may be ceramic powder including at least one of alumina (Al₂O₃), silica (SiO₂), barium peroxide (BaO₂), barium oxide (BaO), titanium oxide (TiO₂), barium titanate (BaTiO₃), BaSrTiO₃, and tantalum oxide (TaAOB).

Oxides with a PA-based perovskite structure, oxides with a PB-based perovskite structure, or oxides with a perovskite structure including at least one of other potential metals may be used as the high-k dielectric material. Specifically, the oxides with the PA-based perovskite structure (e.g., BaZrO₃, SrTiO₃, BaSnO₃, CaSnO₃, and PbTiO₃), the oxides with the PB-based perovskite structure (e.g., MgO, MgTiO₃, NiSnO₃, CaTiO₃, and Bi₂(SnO₃)), and the oxides with the perovskite structure including other potential metals may be used as the high-k dielectric material.

In addition, a material including one or more of the ceramic power and one or more of the oxides may be used as the high-k dielectric material.

In this operation, the high-k dielectric material may be deposited by chemical vapor deposition (CVD) or physical vapor deposition (PVD).

Specifically, CVD or PVD may be used for deposition of the high-k dielectric material.

CVD is a process in which a material to be deposited (i.e., a high-k dielectric material) is injected in a gaseous state into a reaction chamber and deposited onto a substrate inside the reaction chamber through high-temperature decomposition or high-temperature chemical reaction.

There are thermal CVD, plasma enhanced CVD, photo CVD, and the like based on reaction energy sources, and there are atmospheric pressure CVD, low pressure CVD, and the like based on process pressures. A high-k dielectric material may be deposited through any one of these CVD methods depending upon required deposition conditions.

PVD is a method of forming a thin film in a vaporized atomic form using a material to be deposited (i.e. a high-k dielectric material) without chemical reaction in a vacuum.

As well known in the art, there are sputtering, electron-beam evaporation, thermal evaporation, laser molecular beam epitaxy, and pulsed laser deposition. A high-k dielectric material may be deposited through any one of PVD methods depending upon required deposition conditions.

The paint layer is implemented with paint, such as carbon black ink or white ink, corresponding to a color of device for which the fingerprint recognition sensor module is employed and making the fingerprint recognition sensor module indistinguishable to the eye. The painting layer preferably has a thickness of 2 μm to 8 μm. When the painting layer has a thickness of less than 2 μm, painting quality and shielding performance are difficult to secure, and when the painting layer has a thickness of more than 8 μm, sensing sensitivity is likely to be reduced.

The UV curing layer for endowing gloss and hardness with a surface may be implemented by coating a UV curing resin in a glossy or matte form, followed by UV curing the resin. The UV curing layer preferably has a thickness of 15 μm to 40 μm. When the UV curing layer has a thickness of less than 15 μm, gloss and hardness are difficult to secure, and when the painting layer has a thickness of more than 40 μm, sensing sensitivity is likely to be reduced. Baking paint may also be coated instead of the UV curing layer. The baking paint may include one of melamine baking paint, acrylic baking paint, and fluoride resin baking paint. Due to excellent high-temperature resistance, a baking paint coating layer formed by coating baking paint does not deform and discolor even when surface mounting technology (SMT) is used as a back-end of line for the fingerprint recognition sensor module.

When a high-k dielectric material is mixed in formation of the functional coating layer, electrostatic capacity is enhanced. Therefore, in spite of thickness increase, the functional coating layer may maintain the same level of performance as when having a small thickness, thereby ensuring reliability of the fingerprint recognition sensor module. In other words, each functional coating layer may be formed by mixing a high-k dielectric material (e.g., ceramic powder with a high dielectric constant) with the material of which the functional coating layer is formed.

Here, a suitable amount of the high-k dielectric material is mixed with the material of the functional coating layer to increase permittivity of the functional coating layer, and the same high-k dielectric material as that coated onto the primer layer may be used.

A nano-coating layer may be additionally formed after the formation of the UV curing layer. The nano-coating layer is a functional coating layer for preventing moisture from infiltrating into the fingerprint recognition sensor module from the outside.

If moisture infiltrates into the fingerprint recognition sensor module due to use conditions and user mistakes, corrosion is induced, thereby reducing a lifespan thereof.

In addition, damage, such as corrosion, degrades an excellent fingerprint recognition rate (e.g., a fingerprint recognition rate of 90% or more) ensured when the product is released, thereby causing low performance.

Therefore, the nano-coating layer is additionally formed to solve the problem of moisture infiltration, thereby preventing a decrease in fingerprint recognition rate due to internal corrosion.

The nano-coating layer may include a material containing at least one component of a fluorine compound, a fluoro-based resin, and Parylene. In addition, well-known components having a waterproofing function may be used as a composite of the nano-coating layer.

In operation S130 of forming the functional coating layer, the functional coating layer may be separately formed and then attached.

For example, a functional coating layer may be formed by sequentially stacking a UV top coating layer, a paint layer, and a shielding layer on a release film, separated from the release film when completely cured, and then aligned with and attached to a sensing plane of the fingerprint recognition sensor module.

The functional coating layer may be attached to the fingerprint recognition sensor module using a curable resin. A thermosetting resin or a UV curable resin may be used as the curable resin. Alternatively, an epoxy resin or an acrylic resin may also be used as the curable resin.

Since the flat and cured functional coating layer is attached to the sensing plane, a concave-convex pattern on the sensing plane is covered with the curable resin layer formed of a curable resin, thereby keeping a surface of the functional coating layer flat.

In operation S140 of attaching a bezel to the superposed sensing regions, a bonding method using an epoxy resin may be used. When the bezel is attached to the periphery of the sensing regions using an epoxy resin, the epoxy resin seals a space between the bezel and the periphery of the sensing regions, thereby preventing moisture infiltration into the space and consequently, enhancing water tightness and durability.

In operation S150 of connecting a connector, the connector is attached to the connection section of the flexible printed circuit board to connect the fingerprint recognition sensor module to a product. The connector may be connected to the connection section directly or through a separate connector link substrate according to product design. The connector (or connector link substrate) may be bonded to the connection section by surface mount technology (SMT), anisotropic conductive adhesive (ACA) bonding, or anisotropic conductive film (ACF) bonding. In this case, a metallic bottom plate may be attached to a bottom surface of the connector to be connected to the connection section. The metallic bottom plate may remove static electricity by ensuring a ground and increase strength of the bottom surface of the fingerprint recognition sensor module. In addition, an electromagnetic interference (EMI) film may be attached to the metallic bottom plate to prevent damage or malfunction due to static electricity.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

1. A fingerprint recognition sensing module having a recognition function of using a fingerprint, comprising:
a patterned flexible printed circuit board comprising a first sensing region in which a first sensing input unit is formed on the flexible printed circuit board, a second sensing region in which a second sensing input unit is formed on the flexible printed circuit board, an ASIC converting a fingerprint sensed through the sensing input units into a digital signal, a chip mounting region in which the ASIC is mounted on the flexible printed circuit board, and a connector outputting the digital signal from the ASIC to an outside of the fingerprint recognition sensing module,
wherein the chip mounting region and the first and second sensing regions are formed in different regions on the same surface of the flexible printed circuit board.

2. A fingerprint recognition sensing module having a recognition function of using a fingerprint, comprising:
a patterned flexible printed circuit board comprising a first sensing region in which a first sensing input unit is formed on the flexible printed circuit board, a second sensing region in which a second sensing input unit is formed on the flexible printed circuit board, an ASIC converting a fingerprint sensed through the sensing input units into a digital signal, a chip mounting region in which the ASIC is mounted on the flexible printed circuit board, and a connector outputting the digital signal from the ASIC to an outside of the fingerprint recognition sensing module,
wherein the chip mounting region is formed on a different surface from the first and second sensing regions.

3. The fingerprint recognition sensing module according to claim 2, wherein the first and second sensing regions are stacked on one surface of the flexible printed circuit board and superposed one above another, and the chip mounting region is separated from the first and second sensing regions.

4. A fingerprint recognition sensing module having a recognition function of using a fingerprint, comprising:
a patterned flexible printed circuit board comprising a first sensing region in which a first sensing input unit is formed on the flexible printed circuit board, a second sensing region in which a second sensing input unit is formed on the flexible printed circuit board, an ASIC converting a fingerprint sensed through the sensing input units into a digital signal, a chip mounting region in which the ASIC is mounted on the flexible printed circuit board, and a connector outputting the digital signal from the ASIC to an outside of the fingerprint recognition sensing module,
wherein the first and second sensing regions are formed on different surfaces of the flexible printed circuit board.

5. The fingerprint recognition sensing module according to claim 4, wherein the first and second sensing regions are formed on opposite surfaces of the flexible printed circuit board, respectively, such that projection planes of the first and second sensing regions are superposed one above another.

6. A fingerprint recognition sensing module having a recognition function of using a fingerprint, comprising:
a patterned flexible printed circuit board comprising a first sensing region in which a first sensing input unit is formed on the flexible printed circuit board, a second sensing region in which a second sensing input unit is formed on the flexible printed circuit board, an ASIC converting a fingerprint sensed through the sensing input units into a digital signal, a chip mounting region in which the ASIC is mounted on the flexible printed circuit board, and a connector outputting the digital signal from the ASIC to an outside of the fingerprint recognition sensing module,
wherein the chip mounting region and the first and second sensing regions have the same projection region when superposed one above another.

7. The fingerprint recognition sensing module according to claim 1, further comprising:
a stiffener between the stacked sensing input units and the ASIC to secure flatness and strength of the sensing input units,
wherein the flexible printed circuit board is folded such that projection planes of the chip mounting region and the first and second sensing regions are superposed one above another.

8. The fingerprint recognition sensing module according to claim 7, wherein the stiffener has a flat surface to be attached to the sensing regions.

9. The fingerprint recognition sensing module according to claim 7, wherein the stiffener has a convex curved surface to be attached to the sensing regions to correspond to a shape of a finger.

10. The fingerprint recognition sensing module according to claim 7, wherein the stiffener is interposed between the sensing regions and the chip mounting region.

11. The fingerprint recognition sensing module according to claim 7, wherein the stiffener has a receiving slot formed on a surface thereof facing the chip mounting region and receiving the ASIC.

12. The fingerprint recognition sensing module according to claim 7, wherein a functional coating layer is formed on surfaces of the stacked first and second sensing regions to increase a fingerprint recognition rate.

13. The fingerprint recognition sensing module according to claim 12, wherein the functional coating layer comprises a primer layer, a paint layer, and a UV curing layer, or a primer layer, a paint layer, and a baking paint coating layer.

14. The fingerprint recognition sensing module according to claim 13, wherein the functional coating layer further comprises a high-k dielectric material layer between the primer layer and the paint layer.

15. The fingerprint recognition sensing module according to claim 12, wherein the functional coating layer has a thickness of 10 μm to 50 μm to increase a sensing rate.

16. The fingerprint recognition sensing module according to claim 12, wherein the functional coating layer comprises a high-k dielectric material to increase electrostatic capacity.

17. The fingerprint recognition sensor module according to claim 7, further comprising:
a bezel surrounding the stacked sensing input units and a side surface of the stiffener attached thereto.

18. The fingerprint recognition sensor module according to claim 15, wherein the bezel is formed of a metallic material conducting electricity, and a portion of the bezel which a user touches with a finger is coated with a nonconductive material.

19. The fingerprint recognition sensor module according to claim 17, wherein the functional coating layer further comprises:
a nano-coating layer surrounding a sensing plane of the stacked sensing input units and a surface of the bezel to prevent infiltration of moisture.

20. The fingerprint recognition sensor module according to claim 1, wherein the first sensing input unit is a transmitter and the second sensing input unit is a receiver, or the first sensing input unit is a receiver and the second sensing input unit is a transmitter.

21. A method of fabricating a fingerprint recognition sensing module, comprising:
(a) preparing a flexible printed circuit board and an ASIC to be mounted on the flexible printed circuit board, and mounting the ASIC on the flexible printed circuit board, the flexible printed circuit board comprising a first sensing region, a second sensing region, a chip mounting region on which the ASIC is mounted, and a connection section to which a connector is connected;
(b) attaching a stiffener to a rear surface of the superposed first and second sensing regions to secure flatness thereof;
(c) forming a coating layer on surfaces of the first and second sensing regions;
(d) attaching a bezel to a periphery of the superposed first and second sensing regions; and
(e) connecting a connector to the connection section of the flexible printed circuit board.

22. The method according to claim 21, wherein (b) attaching the stiffener comprises:
attaching the stiffener after the first and second sensing regions are superposed one above another by folding the flexible printed circuit board.

23. The method according to claim 21, wherein (c) forming the coating layer comprises:
attaching a functional coating layer formed through a separate process to the surfaces of the first and second sensing regions.
